(19) United States
(12) Patent Application Publication
(10) Pub. No.: US 2015/0168672 A1
(43) Pub. Date: Jun. 18, 2015

(54) MIRROR ARRAY

(71) Applicant: Frank SANNS, JR., Pittsburgh, PA (US)

(72) Inventor: Frank SANNS, JR., Pittsburgh, PA (US)

(21) Appl. No.: 14/103,953

(22) Filed: Dec. 12, 2013

(51) Int. Cl. G02B 7/183

(52) U.S. Cl. CPC G02B 7/183

(57) ABSTRACT

A reflective device and method for generating an image from a reflective device are provided. The reflective device includes an array of reflective elements, each reflective element capable of reflecting at least a portion of light from a light source. The array of reflective elements is arranged in a predetermined configuration that reflects the light to generate the predetermined shape. Another reflective device includes at least one refractive element positioned between the light source and an external surface, the refractive element is configured to modify the light from the light source to generate the predetermined shape on the external surface. The method for generating an image having a predetermined shape is also provided.

### FIELD OF THE INVENTION

The application generally relates to a reflective device and method of generating an image from a reflective device. The application relates more specifically to an array of reflective elements and a method for generating a predetermined shape from an array of reflective elements.

### BACKGROUND

Reflective surfaces may reflect lights of various brightness and generate geometric shapes. The intensity of such reflections may vary based upon the source of the lighting (indoor, sunlight, etc.) while the origins and shapes of the reflections may change endlessly with the movement of the reflective surface.

Although such reflections are generally random in shape and brightness, it may be desirable to control the shape and brightness of the reflection to obtain organized reflections or refractions or combinations thereof. Using organized reflections or refractions, it is possible to form the shape of a predetermined image such as a logo to indicate authenticity or branding of the article.

Currently, existing devices may concentrate light with simple convex lenses or concave mirrors, e.g., a telescope. The concentration of the light is used to form a real or virtual image based upon a distant object. However, independent of the distant object, the concentrated light forms no predetermined shape or image.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a device for generating a predetermined shape from a light source, the device including an array of reflective elements, each reflective element capable of reflecting at least a portion of the light. The array of reflective elements is arranged in a predetermined configuration that reflects the light to generate the predetermined shape.

Another embodiment relates to a device for generating a predetermined shape from a light source, the device including at least one refractive element, and an array of reflective elements, each reflective element capable of redirecting at least a portion of the light. The array of reflective elements is arranged in a predetermined configuration, and the refractive element and the array of reflective elements generate the predetermined shape on an external surface.

Another embodiment relates to a method for generating a predetermined shape from a light source, the method including providing a device having an array of reflective elements, arranging the array of reflective elements in a predetermined configuration, exposing the array of reflective elements to the light, reflecting at least a portion of the light exposed to the array of reflective elements, and forming the predetermined shape on an external surface with the reflected light.

Alternative exemplary embodiments relate to other features and combinations of features as may be generally recited in the claims.

### BRIEF DESCRIPTION OF THE FIGURES

FIG. 1 is an exemplary embodiment of a micro array according to an embodiment of the disclosure.

FIG. 2 is an exemplary embodiment of a micro array and a refractive element according to an embodiment of the disclosure.

FIG. 3 is an exemplary embodiment of an apparatus including a device according to an embodiment of the disclosure.

FIG. 4 is a schematic view of reflective surfaces reflecting light from a light source to form an image according to an embodiment of the disclosure.

FIG. 5 is an exemplary embodiment of an apparatus including reflective surfaces arranged in a mirror image of an image to be formed according to an embodiment of the disclosure.

FIG. 6 is an exemplary embodiment of an apparatus including reflective surfaces arranged in a spaced apart mirror image of an image to be formed according to an embodiment of the disclosure.

FIG. 7 is an exemplary embodiment of an apparatus including reflective surfaces arranged differently from an image to be formed according to an embodiment of the disclosure.

### DETAILED DESCRIPTION OF THE EXEMPLARY EMBODIMENTS

Provided are a method and device for generating a predetermined shape from a light source. Embodiments of the present disclosure, in comparison to devices and methods not using one or more of the features disclosed herein, increase efficiency of generating an image, decrease power used to generate an image, increase difficulty associated with replicating a device, or a combination thereof.

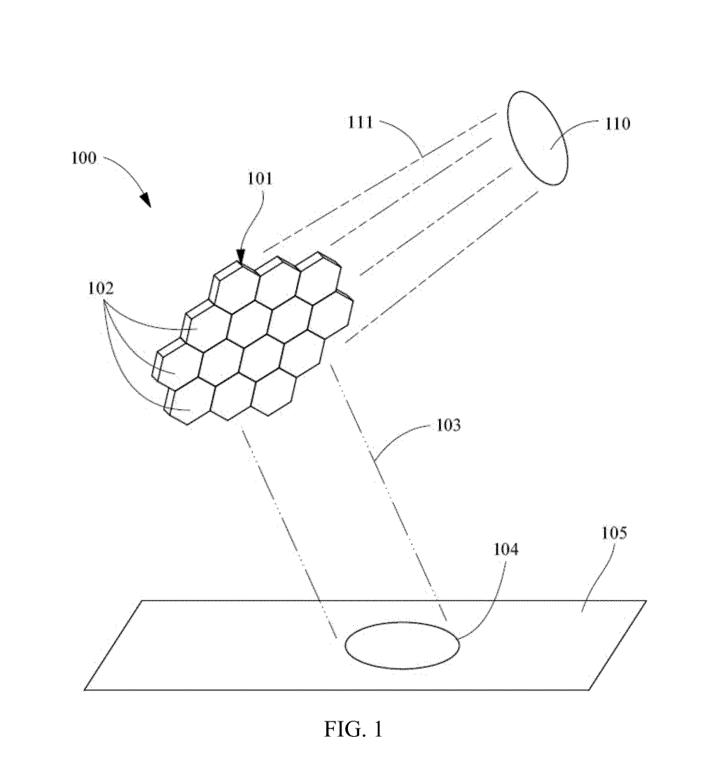

Referring to FIG. 1, in one embodiment, a device 100 for generating a predetermined shape 104 from a light source 110 includes an array 101 having a plurality of reflective elements 102. Each of the reflective elements 102 is capable of reflecting at least a portion of light 111 from the light source 110 to provide a reflection 103. In one embodiment, the reflections 103 from the array 101 generate at least one image. In another embodiment, the reflective elements 102 in the array 101 are arranged in a predetermined configuration to reflect the light 111 and generate the image in the predetermined shape 104. The predetermined shape 104 may be any suitable predetermined shape such as, but not limited to, a trademark logo, a number, a character, a time stamp, a time display such as a digital clock may provide, or a combination thereof.

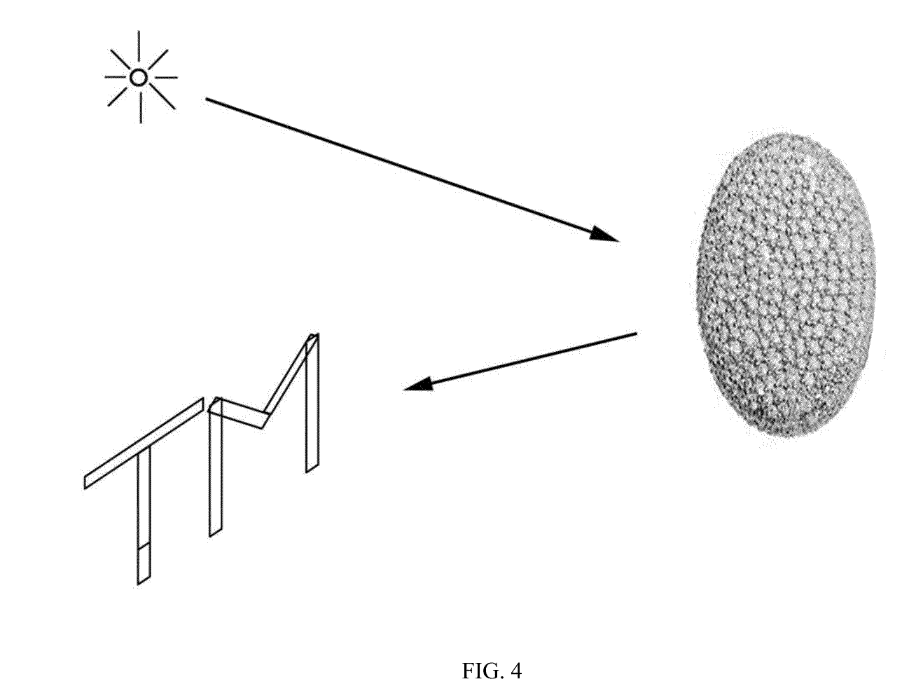

Referring to FIGS. 4-7, to generate the image in the predetermined shape 104, an orientation of each of the reflective elements 102 is adjusted to provide an angle of incidence equal to an angle of reflectance. Providing the angle of incidence equal to the angle of reflectance forms the image in the predetermined shape 104 at a desired location. In one embodiment, the orientation of each of the reflective elements 102 is adjusted to generate the image in the predetermined shape 104 from reflective elements 102 including various shapes, sizes, and/or positions. In another embodiment, adjusting the orientation of each of the reflective elements 102 permits generating the image in the same predetermined shape 104 from a plurality of different predetermined configurations.

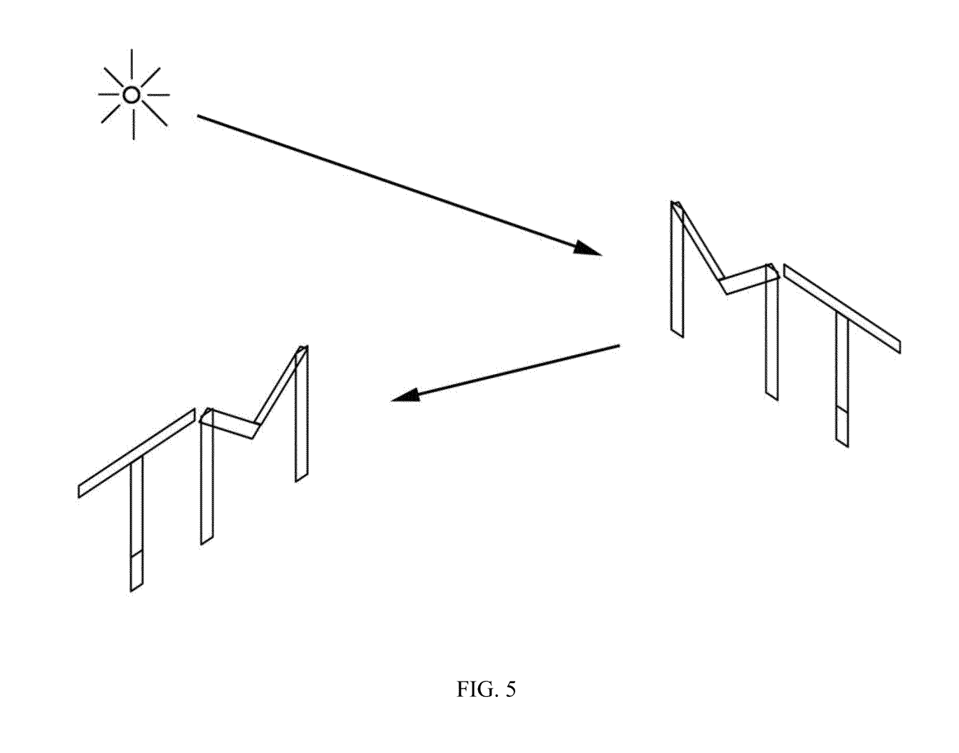

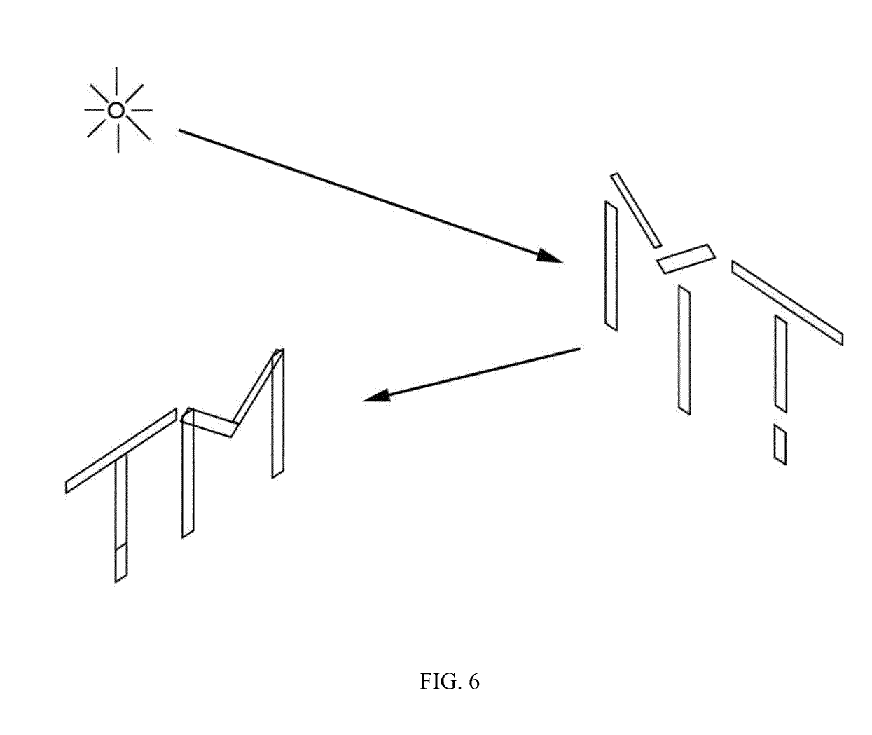

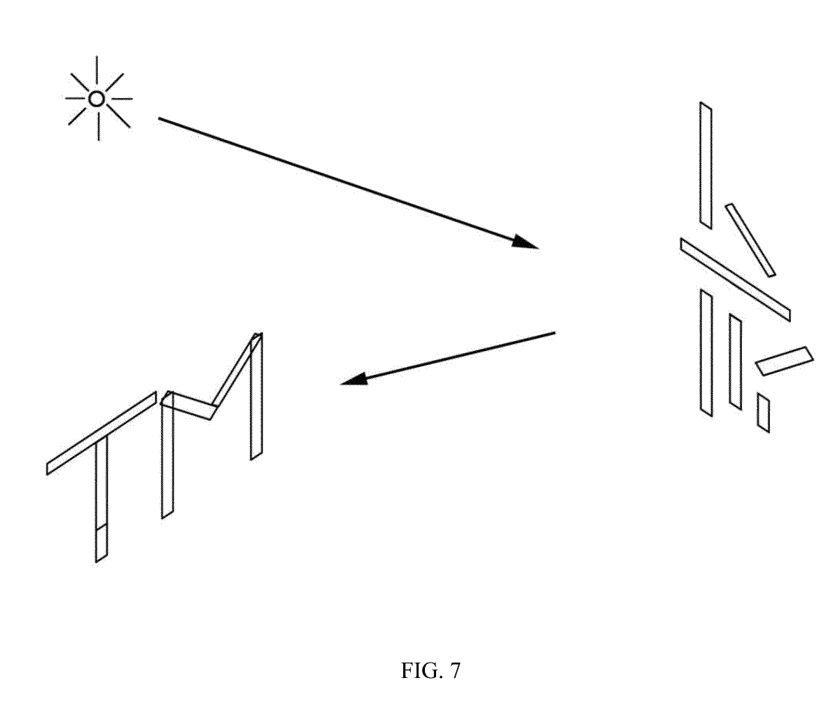

For example, referring to FIG. 5, in one embodiment, the reflective elements 102 are positioned in a mirror image of the predetermined shape 104, with each of the reflective elements 102 forming a portion of the predetermined shape equivalent to a shape, a size, and a relative position of the reflective element 102. Referring to FIG. 6, in another embodiment, by adjusting the orientation (e.g., angle) of each of the reflective elements 102, the reflective elements 102 including increased spacing form the same predetermined shape 104 as in FIG. 5. Referring to FIG. 7, in an alternate embodiment, by adjusting the orientation of each of the reflective elements 102, the reflective elements 102 including differing shapes, sizes, and positions form the same predetermined shape 104 as in FIG. 5 and FIG. 6. As seen in FIG. 7, the predetermined shape 104 may be generated from the reflective elements 102 in the predetermined configuration that appears entirely different from the predetermined shape 104, by adjusting the orientation of the reflective elements 102.

In one embodiment, the orientation of the reflective elements 102 generates differing images as the reflective elements 102 are moved relative to the light source 110 and/or an external surface 105. In another embodiment, the differing images include, but are not limited to, slight variations that create the perception of animation, color changes, shape changes, or a combination thereof.

The array 101 includes any suitable amount of reflective elements 102 situated in an ordered geometry relative to each other to generate the predetermined shape 104 of the image. In one embodiment, a suitable amount of reflective elements 102 is determined by a complexity and/or brightness of the image. For example, an increased amount of the reflective elements 102 permits increased brightness and/or complexity of the generated image. In another embodiment, the ordered geometry of the reflective elements 102 includes rows and columns forming a sheet. In a further embodiment, the reflective elements 102 are situated to form a convex or concave reflective face.

In an alternate embodiment, the device 100 for generating the predetermined shape 104 from the light source 110 includes a single reflective element 102, such as, but not limited to, a piece of metal, glass, crystal, or other suitable reflective material. The single reflective element 102 is micro-curved to form a single contoured element configured to focus the reflections 103 and generate the image in the predetermined shape 104.

The reflective elements 102 include any suitable reflective surface for generating an image corresponding to a configuration of the reflective elements 102. The image may be a real image, a virtual image, a pseudo-real image, or a pseudo-virtual image. For example, normally a telescope provides a real image for a user. That is, the user sees a real image of what appears through the lens, parabolic mirror, or arrays of such. A real image may be a projection of some distance object onto a screen. In contrast, a pseudo image represents an image of the reflector, or mirrors. A person may look at, e.g., a watch, and see the pseudo-image of, e.g., a logo, in the reflections of the watch elements coming to the person's eye. What the person sees is a pseudo-real image.

A suitable reflective surface includes, but is not limited to a mirrored surface, a metal, a metalized coating, a dielectric coating, or a combination thereof. The surface quality (color, reflecting quality, etc.) of the reflective element 102 determines the reflection quality of the reflections 103, which ultimately affect the quality of the generated image. For example, in one embodiment, the reflective element 102 maintains the color of the light 111 in the reflections 103. In another embodiment, a colored reflective surface of the reflective element 102 tints, or changes, the color of the light 111 in the reflections 103.

In one embodiment, the array 101 and or the reflective elements 102 include additional features such as, but not limited to, diffraction gratings, dielectric films, holograms, or a combination thereof. In another embodiment, a surface treatment (metallization, precipitation with metal, etc.) modifies the reflectivity of the reflective elements 102, such as to increase the reflectivity of the reflective elements 102 or make them highly reflective. In particular, wave length ranges of interest may be taken into consideration in that a coating which deflects infrared light having a high degree of efficiency may be selected for an infrared application, for example. Other suitable wave lengths include, but are not limited to, ultra-violet light, microwaves, radio waves, or a combination thereof.

Unlike reflecting telescopes which use one or more mirrors to focus and/or amplify light upon a focal point, the reflection 103 from each of the reflective elements 102 in the array 101 generates a corresponding bright dot, line, and/or shape that forms a portion of the image. The reflective elements 102 are positioned in the predetermined configuration to focus the reflections 103 and generate the predetermined shape 104 from a composite of the corresponding bright dots, lines, and/or shapes. For example, in one embodiment, the reflective elements 102 are arranged in a 5×10 array to provide 50 corresponding bright dots that come together as the composite to form the predetermined shape 104. In another embodiment, each reflective element 102 is capable of being pivoted independent of the other reflective elements 102. Independently pivoting each reflective element 102 varies the direction and/or shape of the reflection 103 provided by the reflective element 102 being pivoted. Additionally, independently pivoting each reflective element 102 permits the arranging of the reflective elements 102 in the array 101 in the predetermined configuration.

A ray tracing program may generate the predetermined shape 104 at any suitable distance, such as near or far reflections 103, or both. An effective focal length of the array 101 and/or the single contoured element corresponds to the suitable distance for generating the predetermined shape 104 from the reflections 103. For example, a short focal length includes aligning the reflective elements 102 in the array 101 to provide reflections 103 that converge proximal to the array 101, corresponding to a reduced distance for generating the predetermined shape 104 in focus. Conversely, a distant focal length includes aligning the reflective elements 102 in the array 101 to provide reflections 103 that converge distal from the array 101, corresponding to an increased distance for generating the predetermined shape 104 in focus.

In one aspect the predetermined configuration may generate a single image or a plurality of images. The plurality of images may include images having the same predetermined shape 104, different predetermined shapes 104, different focal lengths, different locations, or a combination thereof. For example, in one embodiment, the reflective elements 102 in the array 101 include both unique elements and shared elements configured to generate at least two of the images at the same or different focal lengths. In another example, the reflective elements 102 redirect a portion or all of the light 111 to two or more other arrays 101, each of the arrays 101 generating the image in a different location.

In one embodiment, the array 101 and/or the single contoured element is capable of generating the predetermined shape 104 from light 111 traveling at any suitable angle. As such, whenever light 111 is present, the device 110 is capable of generating the predetermined shape 104. In another embodiment, the array 101 and/or the single contoured element provides reflections 103 at a plurality of various angles that converge at more than one location to provide more than one image. The light source 110 is any suitable light source for providing the light 111. Suitable light sources include, but are not limited to, single, multiple, natural (sunlight, moonlight, etc.), ambient, diffuse, concentrated, artificial (incandescent bulbs, fluorescent bulbs, high-intensity discharge (HID) bulbs, light emitting diodes (LEDs), etc.), or a combination thereof.

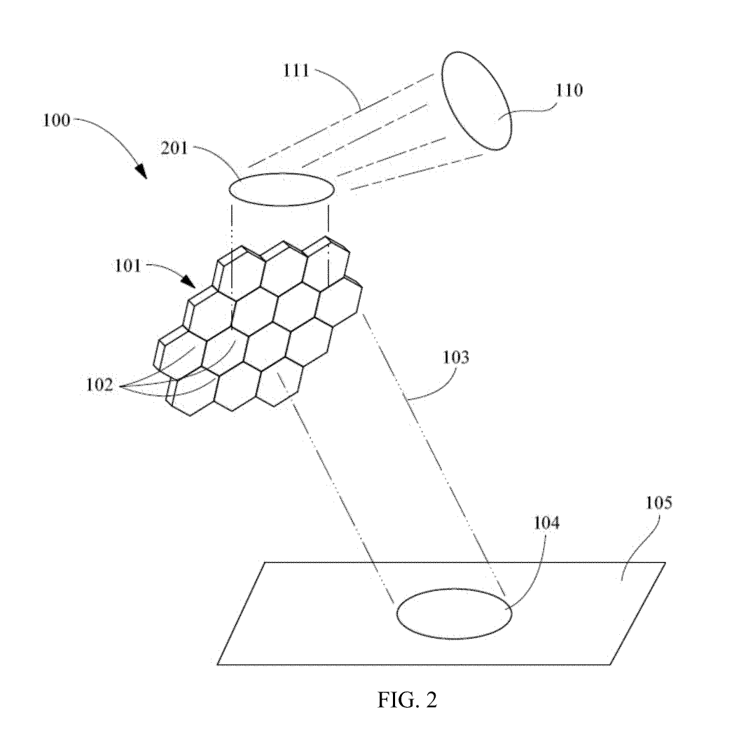

Referring to FIG. 2, in one embodiment, the device 100 includes at least one refractive element 201 and at least one reflective element 102. In another embodiment, the refractive element 201 and the reflective element 102 together generate the predetermined shape 104. In one embodiment, one or more of the refractive elements 201 are positioned between the light source 110 and the reflective element 102. In another embodiment, one or more of the refractive elements 201 are positioned between the reflective element 102 and the external surface 105. Each of the refractive elements 201 is configured to alter at least one property of the light 111 and/or the reflections 103.

Suitable properties of the light 111 and/or reflections 103 to be altered include, but are not limited to, intensity, concentration, focus, shape, color, orientation, interference (e.g., diffraction, Fresnel), phase (e.g., three-dimensional or holographic effects), or a combination thereof. For example, in one embodiment, the refractive element 201 is colored to tint, or change, the color of the light 111 passing there through. In another embodiment, the colored reflective surface of the reflective element 102 is combined with the colored refractive element 201 to generate a multicolored image. In a further embodiment, at least two of the reflective elements 102 in the array 101 are uniquely coated to provide a photorealistic image. Phase information may be used to produce virtual, real, or holographic images with a suitable nano array. One suitable nano array includes, but is not limited to, an array on the order of a quarter the wavelength of light (i.e., a hundred nanometers).

In one embodiment, the reflective elements 102 in the array 101 are arranged in the predetermined configuration to generate all or substantially all of the predetermined shape 104 of the image. In another embodiment, one or more of the refractive elements 201 alter one or more properties of the image other than the predetermined shape 104. For example, in one embodiment, one or more of the refractive elements 201 are placed between the light source 110 and the array of reflective elements 102 to alter the color and concentration of the light 111 while the arrangement of the reflective elements 102 generates the predetermined shape 104. In another example, one or more of the refractive elements 201 are placed between the array 101 and the external surface 105 to alter the focus of the predetermined shape 104 generated by the predetermined configuration of the reflective elements 102.

In an alternate embodiment, one or more of the refractive elements 201 are configured to generate all or substantially all of the predetermined shape 104 of the image (e.g., a fully refractive array 101). For example, in one embodiment, internal light may be directed through one or more of the refractive elements 201, each refractive element 201 configured to generate all or substantially all of the predetermined shape 104 of the image without the reflective element 102. In another example, the array 101 of reflective elements 102 reflects the predetermined shape 104 generated by the one or more refractive elements 201, without altering the predetermined shape 104.

In one embodiment, one or more of the refractive elements 201 are configured to generate a first portion of the image, and the reflective elements 102 are arranged in the predetermined configuration to generate a second portion of the image. Together, the first portion and the second portion form the image having the predetermined shape 104.

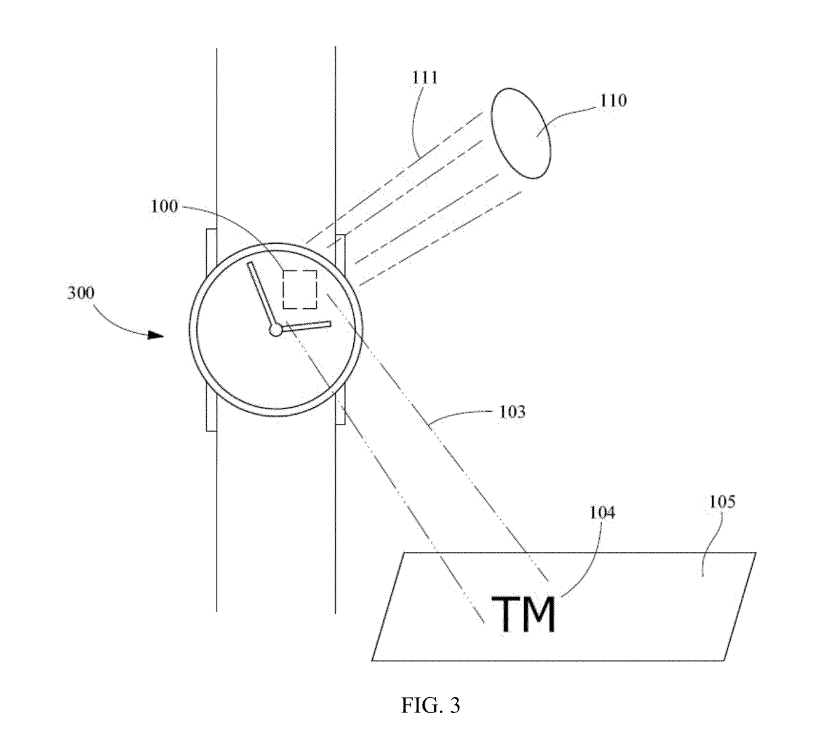

Referring to FIG. 3, in one embodiment, the device 100 forms a portion of an article 300. The article 300 may be any suitable article such as, but not limited to, a watch, a phone, a bracelet, a necklace, a visual display, or a combination thereof. In another embodiment, the device 100 is positioned within the article 300, on an external portion of the article 300, on multiple portions of the article 300, or a combination thereof. For example, the device 100 may be positioned on or in a watch face, a watch bezel, a watch band, a watch hand, a watch marker, a jewel, an ornament, a candle holder, a candelabra, or a combination thereof. In a further embodiment, the light source 110 may be external or internal to the article 300.

In one embodiment, the reflective elements 102 are arranged in the predetermined configuration, and then secured. The securing of the reflective elements 102 retains the predetermined configuration to continuously generate the same predetermined shape 104. For example, the reflective elements 102 may be arranged and secured in the predetermined configuration corresponding to a company logo, such that whenever light reflects off of the array 101 the predetermined shape 104 of the company logo is generated. Generating a company logo in this manner may evidence authenticity of the article, and/or provide increased security against unauthorized copying the article.

In an alternate embodiment, the reflective elements 102 remain pivotable, permitting varying of the predetermined configuration of the reflective elements 102 to provide a plurality of different predetermined shapes 104. In another embodiment, the reflective elements 102 are pivoted to form animations from the plurality of different predetermined shapes 104. In a further embodiment, the plurality of reflective elements 102 in the array 101 is controlled by any suitable device for positioning the reflective elements 102 in the predetermined configuration to generate the image or a motion. Suitable devices include, but are not limited to, electrical devices, electro-optical devices, acousto-optical devices, magneto-optical devices, or a combination thereof. For example, the plurality of reflective elements 102 may be controlled by a processor. The processor is connected to a plurality of actuators, each actuator situated on one of the reflective elements 102. The actuators pivot the reflective elements 102 according to signals received by the processor. In order to implement control commands of the processor, the particular actuator has additional control electronics. In an alternative embodiment the control electronics may be centrally located to supply all of the actuators.

In another embodiment, either a capacitive or thermal actuator system is used to pivot the reflective elements 102. For example, in one embodiment, an address electrode is used in the capacitive control of the reflective elements 102. A deflection of the reflective elements 102 is determined by the voltage between the address electrode and the reflective elements 102. Any angle of the reflective elements 102 with respect to the array 101 is thus settable. The control may be performed by pulse width modulation. In another example, the thermal actuator system achieves pivoting of the mirror elements by using currents of different intensities resulting in differentiated heating of a micromechanical structure.

Each reflective element 102 has an associated switching time, which is the amount of time it takes for the reflective element 102 to go from a first position to a second position. The switching time of each individual reflective element 102 is any suitable switching time such as, but not limited to, less than 10 milliseconds, less than 5 milliseconds, less than 2 milliseconds, less than a millisecond, between about 2 milliseconds and about 10 milliseconds, or any combination, sub-combination, range, or sub-range thereof. The switching time of the reflective element 102 corresponds to the amount of time it takes for the device 100 to switch between predetermined shapes 104.

In one embodiment, the processor is connected to an input device in order to pivot the reflective elements 102. The input device includes any suitable device for providing signals to the processor such as, but not limited to, a watch. For example, in one embodiment, the watch provides input to the processor indicating the current time, and in response the processor signals the actuators to pivot the reflective elements 102. Pivoting the reflective elements 102 changes the predetermined configuration to generate a new predetermined shape 104. In another embodiment, the watch provides input to the processor at specific time intervals to change the predetermined shape 104 at those times. In a further embodiment, the watch provides input to the processor every minute to change the predetermined configuration and generate the predetermined shape 104 corresponding to the current time. In an alternate embodiment, the predetermined configuration is changed to generate various predetermined shapes 104 not corresponding to the time.

In an alternate embodiment, the processor is programmed with a plurality of predetermined configurations. The processor is capable of signaling the actuators to change the predetermined configuration based upon any suitable parameter. Suitable parameters may include a time interval set by the processor, light intensity, or a combination thereof. In another embodiment, the reflective elements 102 are pivoted concurrently with the turning on or off of the light source 110 to create a predetermined effect. For example, in one embodiment, the light source 110 is turned off while the reflective elements 102 are pivoted and turned back on when the reflective elements reach the predetermined configuration. In a further embodiment, the processor is capable of signaling the actuators to change the predetermined configuration based upon a user command such as a push button or dial.

Manufacturing methods include any suitable method such as, but not limited to, molding, stamping, oriented pave, micro or laser machining, or combinations thereof. In one embodiment, the array 101 is micromechanically manufactured using silicon, large-scale production, permitting the manufacture of arrays 101 having a large number of reflective elements 102.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the reflective elements 102 in the array 101 as shown in the various exemplary embodiments is illustrative only. Although only a few embodiments have been described in detail in this disclosure, those who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application.

What is claimed is:

1. A device for generating a predetermined shape from a light source, the device comprising:
an array of reflective elements, each reflective element capable of reflecting at least a portion of the light;
wherein the array of reflective elements is arranged in a predetermined configuration; and
wherein the predetermined configuration of the array of reflective elements reflects the light to generate the predetermined shape.

2. The device of claim 1, wherein the predetermined shape includes a plurality of shapes.

3. The device of claim 1, wherein the light source is selected from the group consisting of an external light source, an internal light source, ambient light, a diffuse light source, and a concentrated light source.

4. A device for generating a predetermined shape from a light source, the device comprising:
at least one refractive element positioned between the light source and an external surface;
wherein the refractive element is configured to modify the light from the light source to generate the predetermined shape on the external surface.

5. The device of claim 4, further comprising:
an array of reflective elements, each reflective element capable of redirecting at least a portion of the light from the light source;
wherein the array of reflective elements are arranged in a predetermined configuration.

6. The device of claim 5, wherein the predetermined configuration of the reflective elements redirects the light without modifying the predetermined shape generated by the at least one refractive element.

7. The device of claim 5, wherein both the predetermined configuration of the reflective elements and the at least one refractive element modify the light from the light source to generate the predetermined shape on the external surface.

8. The device of claim 5, wherein at least one of the at least one refractive elements is positioned between the light source and the array of reflective elements.

9. The device of claim 5, wherein the at least one of the at least one refractive elements is positioned between the array of reflective elements and the external surface.

10. The device of claim 5, wherein at least one of the at least one refractive elements is positioned between the light source and the array of reflective element, and at least one of the at least one refractive elements is positioned between the array of reflective elements and the external surface.

11. A method for generating a predetermined shape from a light source, the method comprising:
providing a device having an array of reflective elements;
arranging the array of reflective elements in a predetermined configuration;
exposing the array of reflective elements to the light;
reflecting at least a portion of the light exposed to the array of reflective elements; and
forming the predetermined shape on an external surface with the reflected light.

12. The method of claim 11, comprising generating the predetermined shape from the predetermined configuration of the array of reflective elements.

13. The method of claim 11, comprising passing the light through a refractive element to alter at least one property of the light.

14. The method of claim 13, wherein the at least one property of the light is selected from the group consisting of intensity, concentration, focus, shape, color, phase, and orientation.

15. The method of claim 14, further comprising generating the predetermined shape from the predetermined configuration of the array of reflective elements.

16. The method of claim 14, further comprising configuring the refractive element to generate the predetermined shape from light passing there through.

17. The method of claim 14, further comprising positioning the refractive element between the light source and the array of reflective elements.

18. The method of claim 14, further comprising positioning the refractive element between the array of reflective elements and the external surface.

19. The method of claim 11, further comprising varying the arrangement of the array of reflective elements to form a plurality of different predetermined configurations corresponding to a plurality of different predetermined shapes.

20. The method of claim 19, further comprising generating the different predetermined configurations based upon the current time.
